(19) United States
(12) Patent Application Publication
(10) Pub. No.: US 2002/0067746 A1
(43) Pub. Date: Jun. 6, 2002

(54) Apparatus for transmitting multi-frame in multiplex transmission and method of doing the same

(76) Inventor: Mitsuhiro Kitagawa, Tokyo (JP)

Correspondence Address: McGinn & Gibb, PLLC, Suite 200, 8321 Old Courthouse Road, Vienna, VA, 22182-3817, US

(21) Appl. No.: 10/002,195

(22) Filed: Dec. 5, 2001

(30) Foreign Application Priority Data
Dec. 6, 2000 (JP) 2000-370863

(51) Int. Cl. H04J 3/02

(52) U.S. Cl. 370/539

(57) ABSTRACT

An apparatus for transmitting a multi-frame in multiplex transmission, includes (a) a first interface through which a plurality of data traffics is input and output, (b) a second interface through which a SONET/SDH frame is received from a SONET/SDH network and through which a SONET/SDH frame produced by multiplexing the data traffics is output to the SONET/SDH network, (c) a mapper which receives the data traffics through the first interface, maps each of the data traffics, in a multi-frame including SONET/SDH frames by the number equal to or greater than the number of the data traffics, to each of the SONET/SDH frames, and transmits the SONET/SDH frames to the second interface, and (d) a demapper which receives a multi-frame which the second interface receives through the SONET/SDH network, extracts each of the data traffics out of each of SONET/SDH frames constituting the multi-frame, and transmits the thus extracted SONET/SDH frames to the first interface.

### BACKGROUND OF THE INVENTION

1. Field of the Invention

The invention relates to an apparatus for and a method of multiplexing and transmitting a plurality of data traffics each having a transmission rate different from a transmission rate of a SONET/SDH frame, through a SONET/SDH network.

2. Description of the Related Art

As the specification for an optical transmission network, the synchronous optical network (SONET) is used in North America, and the synchronous digital hierarchy (SDH) is used internationally. These specifications are almost identical to each other, though they are different from each other in a used language and a format for multiplexing.

A signal transmission rate is fixed in both of the specifications. For instance, the STS-1 signal and the STS-3c signal are designed to have rates of 50 Mbps and 155 Mbps, respectively, in the SONET specification, and the STM-1 signal is designed to have a rate of 155 Mbps in the SDH specification.

In the specification, the term “SONET/SDH network” means a network which operates in accordance with the SONET or SDH specification, and the term “SONET/SDH frame” means a frame formed in accordance with the SONET or SDH specification.

In the SONET/SDH network, a plurality of user data traffics are multiplexed before transmission thereof by mapping a SONET/SDH frame having a relatively low transmission rate, onto a SONET/SDH frame having a relatively high transmission rate.

FIG. 1 is a view showing how user data traffics are multiplexed in the conventional SONET/SDH network.

As illustrated in FIG. 1, in the conventional SONET/SDH network, a plurality of SONET/SDH frames L1 to Lm each having a relatively low transmission rate and each including user data traffics U1 to Um (“m” is an integer equal to or greater than 2), respectively, is multiplexed to a SONET/SDH frame 102 having a transmission rate higher than the transmission rate of the SONET/SDH frames L1 to Lm, by mapping the SONET/SDH frames L1 to Lm onto the SONET/SDH frame 102.

Each of the SONET/SDH frames L1 to Lm has a frame comprised of VC-3/4 defined in the SDH specification, and the SONET/SDH frame 102 has a frame comprised of STM-1, for instance. Each of the SONET/SDH frames L1 to Lm has an overhead “OH”.

Since there have been developed various communication systems which making access through the SONET/SDH network, it is now necessary to effectively transmit data traffics having different transmission rates, through the SONET/SDH network. However, as mentioned above, since a signal transmission rate is fixed in the SONET/SDH network, it is quite difficult or almost impossible to meet with the above-mentioned necessity. For instance, a signal is transmitted at a rate of 100 Mbps in Fast Ethernet. If the signal is transmitted in the SONET/SDH network, the signal has to be transmitted as the STS-3c signal or the STM-1 signal both having a transmission rate of 155 Mbps. As a result, an efficiency at which a band is used is about 60% at maximum.

In order to avoid this problem, virtual concatenation may be used. However, even in the virtual concatenation, a transmission rate of a multiplexed signal is limited to a rate V×N wherein V indicates a transmission rate of a SONET/SDH frame and N indicates an integer. For instance, if the signal STS-1 having a transmission rate of 50 Mbps or the signal VT 1.5 having a transmission rate of 1.5 Mbps is used, a transmission rate of a multiplexed signal would be 50N Mbps or 1.5N Mbps where N is an integer, resulting in that desired results cannot be always obtained.

In addition, in the virtual concatenation, one data traffic is transmitted through a plurality of paths. Hence, each of the paths may be transmitted through different lines in a network. Accordingly, a receiver has to absorb delay generated among the paths, and furthermore, an apparatus for monitoring and/or protecting lines is unavoidably complicated in structure.

Japanese Unexamined Patent Publication No. 2000-36797 has suggested an apparatus for multiplexing and transmitting a signal, including a signal transmitter and a signal receiver. The signal transmitter is comprised of a first circuit which divides a first transmission signal into N transmission signals each having a transmission rate 1N smaller than a transmission rate of the first transmission signal, a plurality of mapping circuits each mapping the N transmission signals and at least one second transmission signal having the same transmission rate as that of the N transmission signals, into transmission paths each having a predetermined format, and a multiplexing circuit which multiplexes signals transmitted from the mapping circuit, and transmits the thus multiplexed signal through a transmission line. The signal receiver is comprised of a second circuit which divides the multiplexed signal transmitted through the transmission line, into the original signals, a plurality of demapping circuits each of which extract a transmission signal mapped into a payload of each of the signals having been divided by the second circuit, a plurality of memories each storing a transmission signal transmitted from each of the demapping circuits, a third circuit which synchronizes transmission signals to one another which transmission signals are transmitted from the memories, based on a repetition pattern in which path-tracing signals are transmitted from the demapping circuits, and a multiplexing circuit which multiplexes the transmission signals transmitted from the memories, to one another.

Japanese Unexamined Patent Publication No. 5-316068 has suggested a SDH accommodation system. In the system, an asynchronous 32 Mb/s signal is converted into a signal having a second transmission rate through a serial process by means of a staff-multiplexing converter. The signal is divided into signals by means of a mapper, and a STM-0 frame is also divided into frames. When data is arranged to the STM-0 frame, digital tertiary group signals in existing networks are absorbed into SDH, which an internationally unified interface, by dispersing the signal in the STM-0 frame.

Japanese Unexamined Patent Publication No. 11-122320 has suggested an interface device including a DS3/DS2 converter which converts a DS3 signal into a DS2 signal, a DS2/DS1 converter which converts a DS2 signal into a DS1 signal, a first memory storing data for compensating for a frequency offset generated when the DS3 signal is converted into the DS1 signal, and transmitting the data in synchronization with a clock signal supplied thereto, a first clock generator which transmits a clock signal to the memory for causing the memory to transmit the data at a data transmission in SONET VT network, a DS1/VT1.5 converter which multiplexes and converts a DS1 signal into a VT1.5 signal in synchronization with the clock signals transmitted from the clock generator, a VT1.5/STS1 converter which multiplexes and converts a VT1.5 signal into a STS1 signal, a STS1/VT1.5 converter which converts a STS1 signal into a VT1.5 signal, a VT1.5/DS1 converter which converts a VT1.5 signal into a DS1 signal, a clock generator which transmits a clock signal in synchronization with a data transmission of DS3 network, a DS1 clock generator which transmits a clock signal in synchronization with the DS1 signal, a second memory storing data for compensating for a frequency offset generated when the STS1 signal is converted into the DS1 signal, and transmitting the data in synchronization with the clock signal transmitted from the DS1 clock generator, a DS1/DS2 converter which multiplexes and converts a DS1 signal into a DS2 signal in synchronization with the clock signal transmitted from the second clock generator, and a DS2/DS3 converter which multiplexes and converts a DS2 signal into a DS2 signal in synchronization with the clock signal transmitted from the second clock generator. By converting the DS3 signal into the VT1.5 signal, signal-multiplexing and signal-converting are facilitated in VT1.5 unit in the SONET network, thereby presenting a direct interface to the DS3 network.

Japanese Unexamined Patent Publication No. 2000-22652 has suggested a method of controlling virtual concatenation channel in which, when a signal is divided into a plurality of channels and then transmitted in SDH network, a sign indicating that the channel is concatenated is inserted into each of the divided channels at a predetermined position or into a multiplexed frame including all of the divided channels, at a predetermined position.

Japanese Unexamined Patent Publication No. 8-163067 has suggested a method of selecting SDH transmission system. A kind of SDH transmission system in an upstream apparatus is transmitted to each of downstream apparatuses through overhead bytes. Receiving the overhead bytes, each of the downstream apparatuses recognizes a kind of the SDH transmission system of a multiplexing device in the upstream apparatus. When the downstream apparatus has recognized a kind of the SDH transmission system of the upstream apparatus, the downstream apparatus informs the upstream apparatus of a kind of its SDH transmission system through overhead bytes.

The above-mentioned problem remains unsolved even in the abovementioned Publications.

### SUMMARY OF THE INVENTION

In view of the above-mentioned problem in the conventional apparatus, it is an object of the present invention to provide an apparatus and a method both of which are capable of multiplexing a plurality of data traffics having a transmission rate different from a transmission rate in a SONET/SDH network, into a single path for making it possible to transmit the data traffics through a SONET/SDH network.

In one aspect of the present invention, there is provided an apparatus for transmitting a multi-frame in multiplex transmission, including (a) a first interface through which a plurality of data traffics is input and output, (b) a second interface through which a SONET/SDH frame is received from a SONET/SDH network and through which a SONET/SDH frame produced by multiplexing the data traffics is output to the SONET/SDH network, (c) a mapper which receives the data traffics through the first interface, maps each of the data traffics, in a multi-frame including SONET/SDH frames by the number equal to or greater than the number of the data traffics, to each of the SONET/SDH frames, and transmits the SONET/SDH frames to the second interface, and (d) a demapper which receives a multi-frame which the second interface receives through the SONET/SDH network, extracts each of the data traffics out of each of SONET/SDH frames constituting the multi-frame, and transmits the thus extracted SONET/SDH frames to the first interface.

It is preferable that the mapper and the demapper are constructed as a single unit.

The mapper may insert an identifier for identifying each of data traffics, into a head in each of the SONET/SDH frames.

The demapper may identify the data traffics, based on the identifier, for reproducing each of the data traffics.

The mapper may insert error-monitoring data for monitoring a transmission error in each of data traffics, into a head in each of the SONET/SDH frames.

The demapper may judge whether there is a transmission error in each of the data traffics, based on the error-monitoring data.

For instance, the error-monitoring data is produced in accordance with BIP-8, in which case, it is preferable that the error-monitoring data is produced in accordance with BIP-8, based on data about a SONET/SDH frame including the same data traffic in the previous multi-frame.

In another aspect of the present invention, there is provided a method of transmitting a multi-frame in multiplex transmission, including the steps of (a) receiving a plurality of data traffics, (b) mapping each of the data traffics, in a multi-frame including SONET/SDH frames by the number equal to or greater than the number of the data traffics, to each of the SONET/SDH frames, and (c) transmitting the SONET/SDH frames through a SONET/SDH network.

The method may further include the steps of (d) detecting a multi-frame out of the SONET/SDH frames received through a SONET/SDH network, (e) extracting each of data traffics out of each of the SONET/SDH frames constituting the multi-frame, and (f) outputting the data traffics externally.

The step (b) may include the step of inserting an identifier for identifying each of data traffics, into a head in each of the SONET/SDH frames.

The method may further include the step of identifying the data traffics, based on the identifier, for reproducing each of the data traffics.

The step (b) may include the step of inserting error-monitoring data for monitoring a transmission error in each of data traffics, into a head in each of the SONET/SDH frames.

The method may further include the step of judging whether there is a transmission error in each of the data traffics, based on the error-monitoring data.

The method may further include the step of producing the error-monitoring data in accordance with BIP-8, in which case, it is preferable that the error-monitoring data is produced in accordance with BIP-8, based on data about a SONET/SDH frame including the same data traffic in the previous multi-frame.

The advantages obtained by the aforementioned present invention will be described hereinbelow.

In the above-mentioned apparatus in accordance with the present invention, the mapper receives the data traffics through the first interface, maps each of the data traffics, in a multi-frame including SONET/SDH frames by the number equal to or greater than the number of the data traffics, to each of the SONET/SDH frames, and transmits the SONET/SDH frames to the SONET/SDH network through the second interface The demapper detects a multi-frame from the SONET/SDH frames which the second interface receives through the SONET/SDH network, extracts each of the data traffics out of each of the SONET/SDH frames constituting the multi-frame, and transmits the thus extracted data traffics through the first interface.

In accordance with the present invention, since the data traffics are multiplexed to one another by mapping each of the data traffics onto each of the SONET/SDH frames, a band width X assigned to each of the data traffics is defined as follows.

In the equation, M indicates the number of the data traffics, and N indicates a transmission rate of the SONET/SDH frames. Accordingly, the band width X assigned to each of the data traffics is dependent on the number of the data traffics, ensuring that the band width X can be determined to be equal to a desired band width. Thus, it would be possible to determine a band width in accordance with a transmission rate of data traffic which is externally input, and assign the band width to the data traffic, ensuring a high efficiency at which a band is utilized.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates frame-multiplexing to be carried out in the conventional SONET/SDH network.

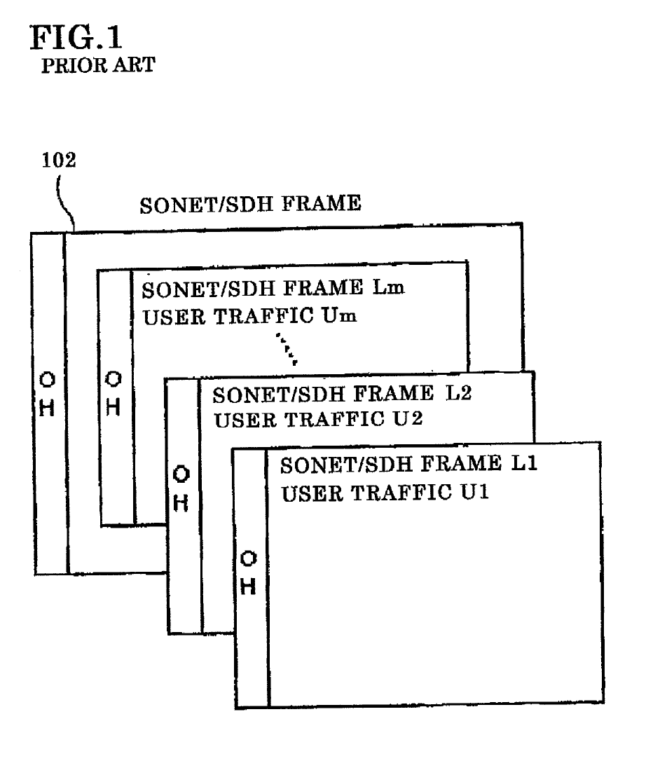

FIG. 2 is a block diagram of an apparatus of multiplexing and transmitting a multi-frame, in accordance with the embodiment of the present invention,

FIG. 3 illustrates a format of a frame generated by the apparatus illustrated in FIG. 2.

FIG. 4 illustrates a frame format used for explaining a multi-frame byte to be inserted into each frames by the apparatus illustrated in FIG. 2.

FIG. 5 is a frame format used for explaining the error-monitoring byte.

### DESCRIPTION OF THE PREFERRED EMBODIMENTS

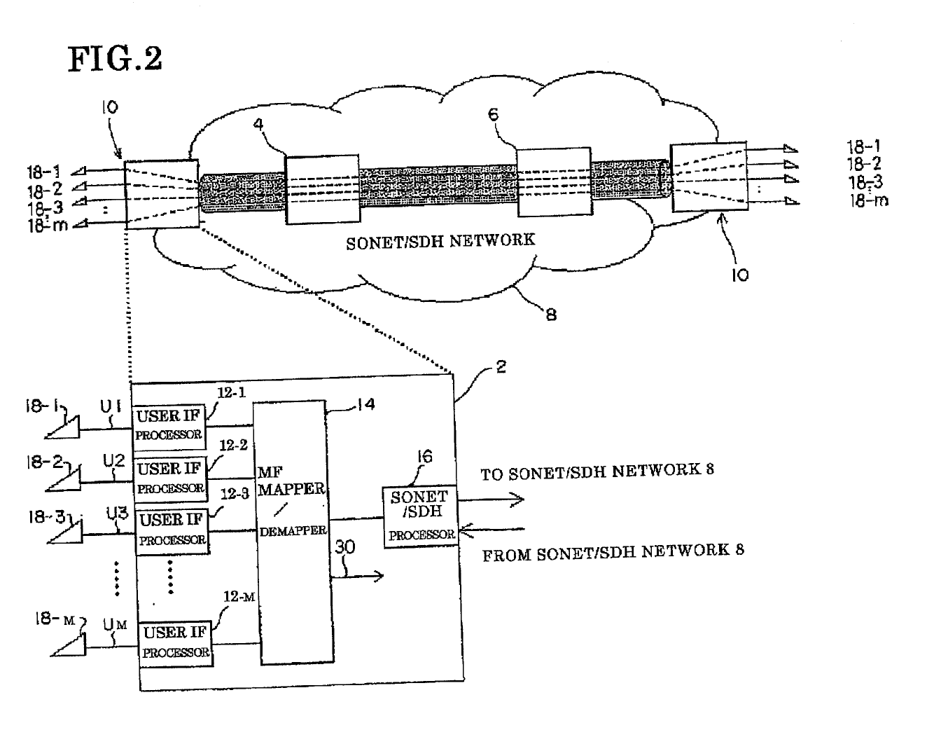

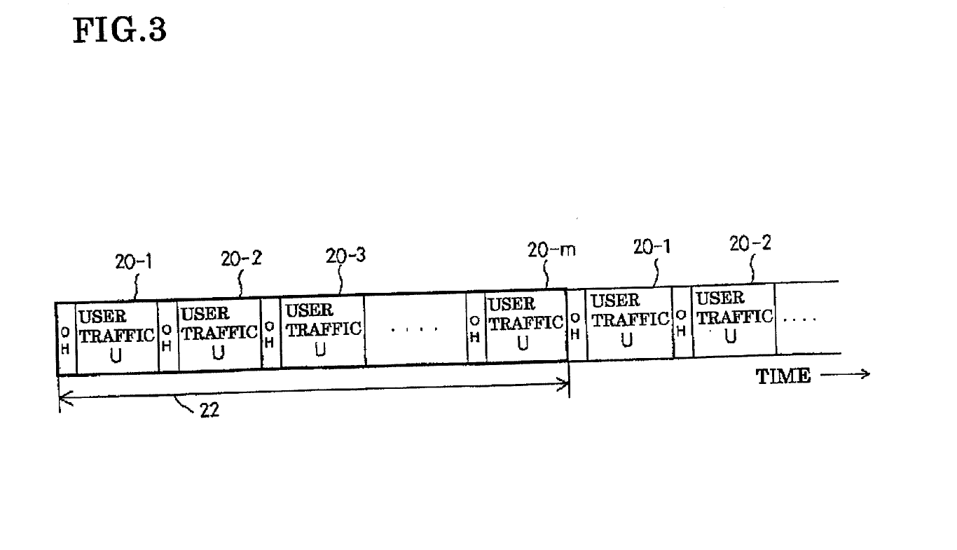

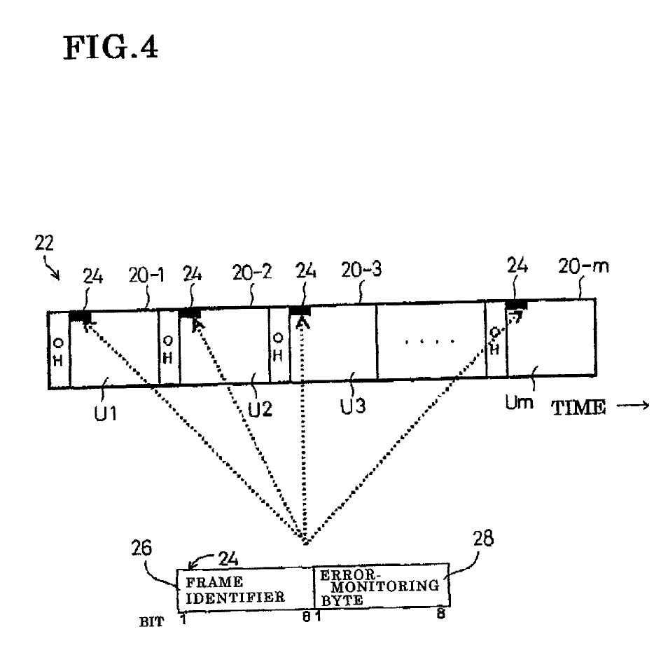

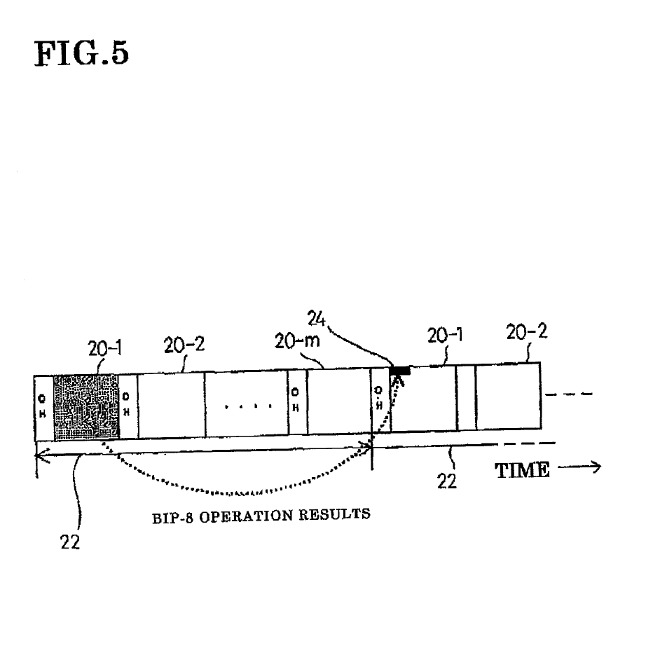

Hereinbelow is explained an apparatus in accordance with the preferred embodiment of the present invention, with reference to FIGS. 2 to 5 wherein FIG. 2 is a block diagram of an apparatus for multiplexing and transmitting a multi-frame, in accordance with the embodiment, FIG. 3 illustrates a format of a frame generated by the apparatus, FIG. 4 illustrates a frame format used for explaining a multi-frame byte to be inserted into each frames by the apparatus, and FIG. 5 is a frame format used for explaining the error-monitoring byte As illustrated in FIG. 2, the apparatus 2 for multiplexing and transmitting a multi-frame is arranged in a SONET/SDH network 8 including SONET/SDH nodes 4 and 6, as an edge node 10. The apparatus 2 is comprised of user interface processors 12-1 to 12-M, a mapper/demapper 14, and a SONET/SDH processor 16.

The user interface processors 12-1 to 12-M are associated with user systems 18-1 to 18-M, respectively, wherein M is an integer equal to or greater than 2. The user interface processors 12-1 to 12-M receive data traffics U1 to UM which are to be transmitted through the SONET/SDH network 8, from the user systems 18-1 to 18-M, and transmits the data traffics U1 to UM having been transmitted through the SONET/SDH network 8, to the user systems 18-1 to 18-M, respectively.

The SONET/SDH processor 16 transmits a SONET/SDH frame produced by the mapper/demapper 14 by multiplexing data traffics, through the SONET/SDH network 8, and receives a SONET/SDH frame having been transmitted through the SONET/SDH network 8.

The mapper/demapper 14 receives the data traffics U1 to UM from the user systems 18-1 to 18-M through the user interface processors 12-1 to 12-M, respectively, maps each of the data traffics U1 to UM, in a multi-frame including the SONET/SDH frames by the number equal to or greater than the number of the data traffics U1 to UM, that is, M in the embodiment, to each of the SONET/SDH frames, and transmits the SONET/SDH frames to the SONET/SDH processor 16.

The mapper/demapper 14 further detects a multi-frame from the SONET/SDH frames which the SONET/SDH processor 16 receives through the SONET/SDH network 8, extracts each of the data traffics U1 to UM out of each of the SONET/SDH frames constituting the multi-frame, and transmits the thus extracted data traffics U1 to UM to the associated user interface processors 12-1 to 12-M.

In addition, the mapper/demapper 14 inserts an identifier for identifying each of the data traffics U1 to UM, into a head in a payload of each of the SONET/SDH frames, when the mapper/demapper 14 constitutes the multi-frame of the SONET/SDH frames.

On the other hand, when the mapper/demapper 14 detects a multi-frame out of the SONET/SDH frames, the mapper/demapper 14 identifies the data traffics U1 to UM, based on the identifier having been inserted into a head in a payload of each of the SONET/SDH frames.

Furthermore, the mapper/demapper 14 inserts error-monitoring data for monitoring a transmission error in each of the data traffics U1 to UM, into a head in a payload of each of the SONET/SDH frames.

When the mapper/demapper 14 detects the data traffics U1 to UM, the mapper/demapper 14 judges whether there is a transmission error in each of the data traffics U1 to UM, based on the error-monitoring data having been inserted into a head in a payload of each of the SONET/SDH frames.

Hereinbelow is explained an operation of the apparatus 2 with reference to FIGS. 3 to 5.

As mentioned below, the mapper/demapper 14 acts as a mapper and a demapper.

First, an operation of the mapper/demapper 14 acting as a mapper is explained.

The mapper/demapper 14 receives the data traffics U1 to UM from the user systems 18-1 to 18-M through the user interface processors 12-1 to 12-M, respectively. Then, the mapper/demapper 14 forms a multi-frame 22 comprised of the same number of SONET/SDH frames 20-1 to 20-M as the number of the data traffics U1 to UM, as illustrated in FIG. 3. Then, the mapper/demapper 14 maps the data traffics U1 to UM onto the SONET/SDH frames 20-1 to 20-M constituting the multi-frame 22. As illustrated in FIG. 3, each of the SONET/SDH frames 20-1 to 20-M has an overhead OH.

As illustrated in FIG. 4, when the mapper/demapper 14 maps the data traffics U1 to UM onto the SONET/SDH frames 20-1 to 20-M, the mapper/demapper 14 inserts a multi-frame byte 24 into a head of a payload in each of the SONET/SDH frames 20-1 to 20-M. The multi-frame byte 24 includes a frame identifier 26 comprised of one-byte data for identifying the data traffics 20-1 to 20-M, and an error-monitoring byte 28 comprised of one-byte data for monitoring an error in each of the data traffics U1 to UM.

As illustrated in FIG. 5, the mapper/demapper 14 produces the error-monitoring byte 28 by carrying out the BIP-8 operation, based on data about a SONET/SDH frame including the same data traffic in the previous multi-frame. Herein, the BIP-8 operation is an operation to be carried out for monitoring an error, in accordance with SONET/SDH.

The mapper/demapper 14 outputs the SONET/SDH frames 20-1 to 20-M constituting the multi-frame 22, to the SONET/SDH processor 16. On receipt of the SONET/SDH frames 20-1 to 20-M from the mapper/demapper 14, the SONET/SDH processor 16 transmits the SONET/SDH frames 20-1 to 20-M through the SONET/SDH network 8.

Second, an operation of the mapper/demapper 14 acting as a demapper is explained.

The SONET/SDH processor 16 receives the multi-frame 22 from the SONET/SDH network 8, and then, transmits the received multi-frame 22 to the mapper/demapper 14. The mapper/demapper 14 separates the received multi-frame 22 into the SONET/SDH frames 20-1 to 20-M, and then, extracts the data traffics U1 to UM out of the SONET/SDH frames 20-1 to 20-M, respectively.

When the mapper/demapper 14 extracts the data traffics U1 to UM, the mapper/demapper 14 identifies the data traffic U1 to UM, based on the frame identifier 26 inserted into a head of a payload in each of the SONET/SDH frames 20-1 to 20-M constituting the multi-frame 22.

In addition, the mapper/demapper 14 checks whether there is a transmission error in each of the data traffics U1 to UM, based on the error monitoring byte 28 indicative of the results of the BIP-8 operation, inserted into a head of a payload in each of the SONET/SDH frames 20-1 to 20-M. If a transmission error is found, the mapper/demapper 14 transmits an error-detection signal in accordance with a frequency at which a transmission error was found. For instance, if the error-detection signal was transmitted from the mapper/demapper 14, an error message is displayed on a display screen to inform a network administrator of occurrence of a transmission error.

The mapper/demapper 14 transmits the extracted data traffics U1 to UM to the associated user interface processor 12-1 to 12-M, and the user interface processor 12-1 to 12-M outputs the data traffics U1 to UM to the associated user systems 18-1 to 18-M.

In accordance with the above-mentioned embodiment, since the data traffics U1 to UM are multiplexed to one another by mapping each of the data traffics U1 to UM onto each of the SONET/SDH frames 20-1 to 20-M, a band width X assigned to each of the data traffics U1 to UM is defined as follows.

X=N/M

In the equation, M indicates the number of the data traffics U1 to UM, and N indicates a transmission rate of the SONET/SDH frames 20-1 to 20-M. Accordingly, the band width X assigned to each of the data traffics U1 to UM is dependent on the number of the data traffics U1 to UM, ensuring that the band width X can be determined to be equal to a desired band width. Thus, it would be possible to determine a band width in accordance with a transmission rate of data traffics which are externally input, and assign the band width to the data traffics, ensuring a high efficiency at which a band is utilized.

For instance, if 24 users share the STM-16 signal having a transmission rate of 2.4 Gbps, the multi-frame 22 is comprised of 24 SONET/SDH frames, and a band width X in each of the data traffics is equal to 100 Mbps.

2.4 Gbps/24=0.1 Gbps=100 Mbps

Accordingly, data traffics in Fast Ethernet having a transmission rate of 100 Mbps can be directly mapped onto SONET/SDH frames, which ensures that data traffics can be transmitted at a band-using efficiency of 100%.

In addition, unlike the virtual concatenation, a transmission rate is not to be limited to NX wherein N indicates an integer and X indicates a transmission rate of the SONET/SDH frame, even after the data traffics U1 to UM have been multiplexed to one another. Furthermore, since the data traffics are transmitted in the same path, there are not caused problems that a delay among paths has to be absorbed in a receiver in the virtual concatenation, and an apparatus for monitoring and/or protecting lines is unavoidably complicated in structure.

In the above-mentioned embodiment, the multi-frame 22 is designed to include the SONET/SDH frames 20-1 to 20-M by the number equal to the number of the data traffics U1 to UM. If it is not always necessary for a band-using efficiency to be 100%, the multi-frame 22 may be designed to include the SONET/SDH frames by the number greater than the number of the data traffics.

In the above-mentioned embodiment, the mapper/demapper 14 is constructed as a single device having the functions of mapping and demapping. However, it should be noted that the apparatus 2 might be designed to include a mapper and a demapper which are separate from each other, in place of the mapper/demapper 14. Even if the apparatus 2 includes a mapper and a demapper, the apparatus 2 could present the same advantages as the abovementioned ones.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-370863 filed on Dec. 6, 2000, 2000 including specification, claims, drawings and summary is incorporated herein by reference in its entirety.

What is claimed is:

1. An apparatus for transmitting a multi-frame in multiplex transmission, comprising:
(a) a first interface through which a plurality of data traffics is input and output;
(b) a second interface through which a SONET/SDH frame is received from a SONET/SDH network and through which a SONET/SDH frame produced by multiplexing said data traffics is output to said SONET/SDH network;
(c) a mapper which receives said data traffics through said first interface, maps each of said data traffics, in a multi-frame including SONET/SDH frames by the number equal to or greater than the number of said data traffics, to each of said SONET/SDH frames, and transmits said SONET/SDH frames to said SONET/SDH network through said second interface; and
(d) a demapper which detects a multi-frame from said SONET/SDH frames which said second interface receives through said SONET/SDH network, extracts each of said data traffics out of each of said SONET/SDH frames constituting said multi-frame, and transmits the thus extracted data traffics through said first interface.

2. The apparatus as set forth in claim 1, wherein said mapper and said demapper are constructed as a single unit.

3. The apparatus as set forth in claim 1, wherein said mapper inserts an identifier for identifying each of data traffics, into a head in each of said SONET/SDH frames.

4. The apparatus as set forth in claim 3, wherein said demapper identifies said data traffics, based on said identifier, for reproducing each of said data traffics.

5. The apparatus as set forth in claim 1, wherein said mapper inserts error-monitoring data for monitoring a transmission error in each of data traffics, into a head in each of said SONET/SDH frames.

6. The apparatus as set forth in claim 5, wherein said demapper judges whether there is a transmission error in each of said data traffics, based on said error-monitoring data.

7. The apparatus as set forth in claim 5, wherein said error-monitoring data is produced in accordance with BIP-8.

8. The apparatus as set forth in claim 7, wherein said error-monitoring data is produced in accordance with BIP-8, based on data about a SONET/SDH frame including the same data traffic in the previous multi-frame.

9. A method of transmitting a multi-frame in multiplex transmission, comprising the steps of:
(a) receiving a plurality of data traffics;
(b) mapping each of said data traffics, in a multi-frame including SONET/SDH frames by the number equal to or greater than the number of said data traffics, to each of said SONET/SDH frames; and
(c) transmitting said SONET/SDH frames through a SONET/SDH network.

10. The method as set forth in claim 9, comprising the steps of:
(d) detecting a multi-frame out of said SONET/SDH frames received through a SONET/SDH network;
(e) extracting each of data traffics out of each of said SONET/SDH frames constituting said multi-frame; and
(f) outputting said data traffics externally.

11. The method as set forth in claim 9, wherein said step (b) includes the step of inserting an identifier for identifying each of data traffics, into a head in each of said SONET/SDH frames.

12. The method as set forth in claim 11, further comprising the step of identifying said data traffics, based on said identifier, for reproducing each of said data traffics.

13. The method as set forth in claim 9, wherein said step (b) includes the step of inserting error-monitoring data for monitoring a transmission error ill each of data traffics, into a head in each of said SONET/SDH frames.

14. The method as set forth in claim 13, further comprising the step of judging whether there is a transmission error in each of said data traffics, based on said error-monitoring data.

15. The method as set forth in claim 13, further comprising the step of producing said error-monitoring data in accordance with BIP-8.

16. The method as set forth in claim 15, wherein said error-monitoring data is produced in accordance with BIP-8, based on data about a SONET/SDH frame including the same data traffic in the previous multi-frame.
